(19) United States
(12) Patent Application Publication
(10) Pub. No.: US 2022/0253814 A1
(43) Pub. Date: Aug. 11, 2022

(54) METHOD AND ELECTRONIC DEVICE FOR AGGREGATING SOURCES FOR PAYMENT TO FINANCIAL TRANSACTION

(71) Applicant: Ademola Oduyemi ODUYEMI, Antwerpen (BE)

(72) Inventor: Ademola Oduyemi ODUYEMI, Antwerpen (BE)

(21) Appl. No.: 17/624,757

(22) PCT Filed: Jul. 3, 2020
(86) PCT No.: PCT/IB2020/056303

§ 371 Date: Jan. 4, 2022

(30) Foreign Application Priority Data
Jul. 4, 2019 (IN) 201941026916

(51) Int. Cl. G06Q 20/08; G06Q 20/40

(52) U.S. Cl. CPC G06Q 20/085; G06Q 20/4015

(57) ABSTRACT

Embodiments herein provide a method of aggregating sources for a payment to a financial transaction using an electronic device (100). The method includes displaying a request for the payment of a specified amount to a payment entity. The method includes determining a plurality of sources that meets at least one payment criteria for the payment. The method includes automatically splitting the specified amount into a plurality of portions based on the at least one payment criteria. The method includes associating at least one portion from the plurality of portions of the specified amount to each of the sources based on the at least one payment criteria. The method includes performing the payment of the specified amount with the payment entity based on the at least one associated portion of the specified amount with each of the sources. The method includes providing a response for the payment of the specified amount.

### FIELD OF INVENTION

The present disclosure relates to an electronic device, and more specifically to a method and the electronic device for aggregating fund sources for a payment to a financial transaction. The present application is based on, and claims priority from an Indian Application Number 201941026916 filed on 4 Jul. 2019, the disclosure of which is hereby incorporated by reference herein.

### BACKGROUND

Online financial transactions are utilized in a variety of environments. In a conventional offline shopping environment, a customer provides a credit/debit card with a merchant to do payment for a product or a service during a check-out. Also, in an Electronic-commerce (e-commerce) environment, the customer provides details of the credit/debit card with an e-commerce website to do payment for the product or the service during the check-out. FIG. 1 is an example scenario illustrating steps following by the customer to do the payment for the product using an existing payment method, according to a prior art. In the example scenario, consider the customer reaches a check-out page of the e-commerce website for purchasing the product as shown in notation (a) of the FIG. 1. Existing payment methods providing by the e-commerce website, includes a credit card payment, a debit card payment, a UPI payment and a digital wallet payment. The customer has the debit card and the credit card where each card has a balance amount of 1500 dollars. However, an amount to pay for the product is 3000 dollars. Consider, the customer is not aware about the balance amount in both the cards. Consider, the customer selects the debit card payment and enters the details of the debit card to do payment for the product as shown in notation (b) of the FIG. 1.

The e-commerce website initiates a payment process using the details of the debit card, in response to receiving an input from the customer to initiate the payment as shown in notation (b) of the FIG. 1. Further, the e-commerce web site detects that the balance amount in the debit card is insufficient to pay the amount of the product. Further, the e-commerce website responses to the customer that the balance amount in the debit card is insufficient to pay the amount of the product as shown in notation (b) of the FIG. 1. In case the customer reinitiates the payment of the product using the credit card, the customer receives the same response from the e-commerce website due to insufficient amount in the credit card. Therefore, the customer is excluded to purchase the product even the customer has the amount to pay the product using multiple fund sources (i.e. the (e.g. the credit card, the debit card, digital wallet, etc.). The existing payment methods does not allow the customer to use the multiple fund sources together for doing the payment for the product in a single transition.

In another example scenario, the customer loses the opportunity to purchase the product due to rejecting the payment of the amount in a first attempt of the payment. In another example scenario, banks charge penalties to the customer for attempting for the payment with the insufficient amount in the fund source. Similarly, the banks charge penalties to the merchant for attempting to receive the payment of the customer having the insufficient amount in the fund source. In another example scenario, the customer is excluded to purchase the product when the fund source of the customer is not acceptable as per the payment methods available at the merchant for the payment. Therefore, during the conventional shopping environment as well as the e-commerce environment, the customer losses the opportunity to purchase the product and the merchant losses the opportunity to sell the product. Thus, it is desired to address the above-mentioned shortcomings or at least provide a useful alternative.

### OBJECT OF INVENTION

The principal object of the embodiments herein is to provide a method and the electronic device for aggregating fund sources for a payment to a financial transaction.

Another object of the embodiments herein is to determine payment parameters of each fund source, where the payment parameters includes at least one of a type of payment to be made, a geo-location at the payment to be made, a payment limit of a source for the payment, a total balance available in the source, a success rate of the source for the payment, a time taken for the payment, a time taken for a refund of the payment, a security method used by the source for the payment, a personal preference of the source for the payment, an additional fee for the payment, an additional fee for the refund, an offered reward for using the source for the payment, and an expiry status of the source.

Another object of the embodiments herein is to define a payment criteria using the payment parameters of each fund source.

Another object of the embodiments herein is to determine fund sources those are eligible for the payment of an amount based on the payment criteria and payment methods associated with a payment entity.

Another object of the embodiments herein is to automatically split the amount into multiple portions based on the payment criteria.

Another object of the embodiments herein is to associate each portion of the amount with an eligible fund source based on the payment criteria.

Another object of the embodiments herein is to perform the payment of the amount by paying each associated portion of the amount with the eligible fund source.

### SUMMARY

Accordingly, the embodiments herein provide a method of aggregating sources for a payment to a financial transaction using an electronic device. The method includes displaying, by the electronic device, a request for the payment of a specified amount to a payment entity. Further, the method includes determining, by the electronic device, a plurality of sources that meets at least one payment criteria for the payment of the specified amount. Further, the method includes automatically splitting, by the electronic device, the specified amount into a plurality of portions based on the at least one payment criteria. Further, the method includes associating, by the electronic device, at least one portion from the plurality of portions of the specified amount to each of the sources based on the at least one payment criteria. Further, the method includes performing, by the electronic device, the payment of the specified amount with the payment entity based on the at least one associated portion of the specified amount with each of the sources. Further, the method includes providing, by the electronic device, a response for the payment of the specified amount.

In an embodiment, where the at least one payment criteria is dynamically defined based on a plurality of payment parameters associated with each of the sources.

In an embodiment, where the plurality of payment parameters includes at least one of a type of payment to be made, a geo-location at the payment to be made, a payment limit of a source for the payment, a total balance available in the source, a success rate of the source for the payment, a time taken for the payment, a time taken for a refund of the payment, a security method used by the source for the payment, a personal preference of the source for the payment, an additional fee for the payment, an additional fee for the refund, an offered reward for using the source for the payment, and an expiry status of the source.

In an embodiment, where the at least one associated portion of the specified amount with each of the sources is confirmed by a user of the electronic device before performing the payment.

In an embodiment, where the at least one associated portion of the specified amount with each of the sources is adjusted based on a feedback from the user of the electronic device before performing the payment.

In an embodiment, where the plurality of sources that meets the at least one payment criteria is associated with a payment method same as a payment method associated with the payment entity.

Accordingly, the embodiments herein provide an electronic device for aggregating sources for a payment to a financial transaction. The electronic device includes a memory, a processor and a split controller, where the split controller is connected to the processor and the memory. The split controller is configured to display a request for the payment of a specified amount to a payment entity. The split controller is configured to determine a plurality of sources that meets at least one payment criteria for the payment of the specified amount. The split controller is configured to automatically split the specified amount into a plurality of portions based on the at least one payment criteria. The split controller is configured to associate at least one portion from the plurality of portions of the specified amount to each of the sources based on the at least one payment criteria. The split controller is configured to perform the payment of the specified amount with the payment entity based on the at least one associated portion of the specified amount with each of the sources. The split controller is configured to provide a response for the payment of the specified amount.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This method and apparatus are illustrated in the accompanying drawings, throughout which like reference letters indicate corresponding parts in the various figures. The embodiments herein will be better understood from the following description with reference to the drawings, in which:

FIG. 1 is an example scenario illustrating steps following by a user to do payment for the product using an existing payment method, according to a prior art.

FIG. 2 is a block diagram of an electronic device for aggregating sources for a payment to a financial transaction, according to an embodiment as disclosed herein;

FIG. 3 is a block diagram of a split controller for splitting a specific amount for the payment, according to an embodiment as disclosed herein;

FIG. 4 is a flow diagram illustrating a method of aggregating the sources and splitting the specific amount for the payment, according to an embodiment as disclosed herein;

FIG. 5 illustrates an example scenario of registering bank cards at the electronic device for aggregating the bank cards for the payment, according to an embodiment as disclosed herein;

FIG. 6 illustrates an example scenario of paying the specific amount of products in an e-commerce application by splitting the specific amount using the electronic device, according to an embodiment as disclosed herein; and

FIG. 7 illustrates an example scenario of paying the specific amount by splitting the specific amount using the electronic device in response to entering the specific amount by the user to the electronic device, according to an embodiment as disclosed herein; and

FIG. 8 illustrates an example scenario of paying the specific amount of the products in the e-commerce application by manually splitting the specific amount, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiments herein provide a method of aggregating sources for a payment to a financial transaction using an electronic device. The method includes displaying, by the electronic device, a request for the payment of a specified amount to a payment entity. Further, the method includes determining, by the electronic device, a plurality of sources that meets at least one payment criteria for the payment of the specified amount. Further, the method includes automatically splitting, by the electronic device, the specified amount into a plurality of portions based on the at least one payment criteria. Further, the method includes associating, by the electronic device, at least one portion from the plurality of portions of the specified amount to each of the sources based on the at least one payment criteria. Further, the method includes performing, by the electronic device, the payment of the specified amount with the payment entity based on the at least one associated portion of the specified amount with each of the sources. Further, the method includes providing, by the electronic device, a response for the payment of the specified amount. The terms “source” and “fund source” used interchangeably throughout this document.

Unlike existing methods and claims, the proposed payment method allows a customer to access all the fund sources of the customer in one go using the electronic device. Further, the proposed payment method allows the customer to manage the fund sources responsibly and intuitively with ease and simplicity using the electronic device. The electronic device aggregates the fund sources and uses the amount in the fund sources for the payment of the amount more than at each fund source. Thus, the proposed payment method minimizes a risk of cart abandonment. Moreover, the proposed payment method aids to overcome a shortage of the amount at each fund source for the payment of the amount more than at each fund source. Further, the proposed payment method provides a fast and efficient seamless payment experience to the customer and a merchant.

Referring now to the drawings, and more particularly to FIGS. 2 through 7, there are shown preferred embodiments.

FIG. 2 is a block diagram of an electronic device 100 for aggregating sources for a payment to a financial transaction, according to an embodiment as disclosed herein. Examples for the source are not limited to, a credit card, a debit card, a loyalty point card, a gift card ACH, a bank account, a promotional coupon/voucher, a digital wallet, a bitcoin cryptocurrency, any other digital currency. Examples for the electronic device 100 are, but not limited to a smart phone, a tablet computer, a personal computer, a desktop computer, a Personal Digital Assistance (PDA), a Point of Sale (POS) system, and the like. In an embodiment, the electronic device 100 includes a split controller 110, a memory 120, a processor 130, and a communicator 160. In an embodiment, a display device such as a computer monitor, a projector, a smart television, and the like is connected to the electronic device 100. In another embodiment, the electronic device 100 includes the split controller 110, the memory 120, the processor 130, the communicator 160 and a display (not shown). The split controller 110 is connected to the memory 120, the processor 130.

The split controller 110 is configured to display a request for the payment of a specified amount to a payment entity. Examples for the payment entity are, but not limited to a customer, a merchant, an e-commerce website, etc. In an embodiment, the request for the payment is displayed to purchase a product or a service. In another embodiment, the request for the payment is displayed to sell the product or the service. In an embodiment, a user (i.e. a customer) of the electronic device 100 can provide details of a plurality of sources to the electronic device 100 in response to viewing a request for the payment. Thus, the split controller 110 is configured to obtain the details of the plurality of sources to the electronic device 100. In another embodiment, the plurality of sources is pre-registered at the electronic device 100, where the user can provide the details of the plurality of sources to the electronic device 100 for registering the plurality of sources to the electronic device before initiating the request for the payment. In response to registering the plurality of sources at the electronic device 100, the user authorizes the electronic device 100 to access and manage the plurality of sources.

The split controller 110 is configured to determine the plurality of sources that meets at least one payment criteria for the payment of the specified amount. In an embodiment, the at least one payment criteria is dynamically defined based on a plurality of payment parameters associated with each of the sources. In an embodiment, the plurality of payment parameters includes at least one of a type of payment to be made, a geo-location where the payment to be made, a payment limit of a source for the payment, a total balance amount available in the source, a success rate of the source for the payment, a time taken for the payment, a time taken for a refund of the payment, a security method used by the source for the payment, a personal preference of the source for the payment, an additional fee for the payment, an additional fee for the refund, an offered reward for using the source for the payment, and an expiry status of the source.

Examples for the type of the payment are, but not limited to a POS instore payment, an online payment, an offline payment, an invoice payment, an e-commerce payment, a m-commerce payment, the payment for a particular type of products, the payment for a particular type of services etc. Example for the type of products are home appliances, apparels, footwears, machineries, etc. Example for the type of services are health service, tour service, spa and saloon service, legal service, etc. In an example, the payment limit of a credit card for the payment is 40 dollars, whereas the payment limit of a debit card for the payment is 10% of the amount available in the debit card. In another example, the payment limit of the credit card for the payment of the tour service is 40 dollars, whereas the payment limit of the credit card for the payment of the health service is 60 dollars. In an example, the success rate is defined in a percentage value. When all the payments performed using the debit card are success, then the success rate of the debit card for the payment is the 100%. When quarter of all the payments performed using the debit card are success, then the success rate of the debit card for the payment is the 25%. Examples for the security method are, but not limited to a Secure Socket Layer (SSL), a Payment Card Industry Data Security Standard (PCI DSS), a tokenization, a Secure Electronic Transition (SET), a digital signature, address verification system etc.

In an example scenario, the credit card is more personally preferred for the payment by the user to purchase the machinery, whereas the debit card is more personally preferred for the payment by the user to purchase the electronic device. In an embodiment, the personal preference of the user is automatically determined based on a payment history of the user. In an example, the additional fee includes a payment processing fee, tax, a service fee, a currency conversion fee etc. Examples for the reward offered for doing the payment or using a specific source for the payment are not limited to, a loyalty point, a gift voucher, a cash back, etc.

In an embodiment, the plurality of sources that meets the at least one payment criteria is associated with a payment method same as a payment method associated with the payment entity. Examples for the payment methods are, but not limited to a debit card payment method, a debit card payment method, a net banking payment method, a digital wallet payment method, etc. In another embodiment, the split controller 110 is configured to identify sources in the plurality of sources, eligible for the payment according to the payment methods available at the payment entity. Further, the split controller 110 is configured to select the eligible sources for determining whether the eligible sources meets the at least one payment criteria for the payment of the specified amount.

The split controller 110 is configured to automatically split the specified amount into a plurality of portions based on the at least one payment criteria. In an example, the specific amount is split into the plurality of portions based on a percentage of the specific amount. The split controller 110 is configured to associate at least one portion from the plurality of portions of the specified amount to each of the sources based on the at least one payment criteria. In an embodiment, the at least one associated portion of the specified amount with each of the sources is adjusted based on a feedback from the user before performing the payment. In an example, the feedback from the user is a manual input from the user. The split controller 110 is configured to change the portion of the specified amount and the source for the payment for the portion of the specified amount based on the manual input of the user.

The split controller 110 is configured to perform the payment of the specified amount with the payment entity based on the at least one associated portion of the specified amount with each of the sources. Consider, the user registered a credit card 1, a credit card 2, a debit card 1 and a debit card 2 for the payment according to the method. In an example scenario, a combination of the credit card 1 and the credit card 2 are used for performing the payment of the amount. In another example scenario, a combination of the debit card 1 and the debit card 2 are used for performing the payment of the amount. In another example scenario, a combination of the credit card 1 and the debit card 2 are used for performing the payment of the amount. In another example scenario, a combination of the credit card 1, the credit card 2, the debit card 1 and the debit card 2 are used for performing the payment of the amount. In an embodiment, the at least one associated portion of the specified amount with each of the sources is confirmed by the user before performing the payment. The split controller 110 is configured to provide a response for the payment of the specified amount. In an embodiment, the response for the payment includes at least one of a payment status of the specific amount, a transaction identifier (ID) for the payment of the specific amount, an order ID, a payment status of each portion of the specific amount, and a transaction ID for the payment of each portion of the total amount.

In an embodiment, the split controller 110 is configured to provide an alert to the user in response to approaching close to a financial budget (e.g. monthly financial budget) and reached the financial budget. In an embodiment, the split controller 110 is configured to provide another alert to the user in response to expiring the source. In an embodiment, the split controller 110 is configured to automatically suggest the source for the payment to the user based on a currency used at the source and a currency required for the financial transaction. In an embodiment, the split controller 110 is configured to perform a currency conversion on the amount in the source for performing the payment.

The processor 130 is configured to execute instructions stored in the memory 120. The memory 120 may include non-volatile storage elements. The memory 120 stores the details of the fund sources registered at the electronic device 100. Examples of such non-volatile storage elements may include magnetic hard discs, optical discs, floppy discs, flash memories, or forms of an Electrically Programmable Memory (EPROM) or an Electrically Erasable and Programmable Memory (EEPROM). In addition, the memory 120 may, in some examples, be considered a non-transitory storage medium. The term “non-transitory” may indicate that the storage medium is not embodied in a carrier wave or a propagated signal. However, the term “non-transitory” should not be interpreted that the memory 120 is non-movable. In some examples, the memory 120 can be configured to store larger amounts of information than the memory 120. In certain examples, a non-transitory storage medium may store data that can, over time, change (e.g., in Random Access Memory (RAM) or cache). The communicator 140 is configured to communicate internally between hardware components in the electronic device 100. Further, the communicator 140 is configured to facilitate the communication between the electronic device 100 and other devices (e.g. servers that support the financial transaction, the display device, etc.).

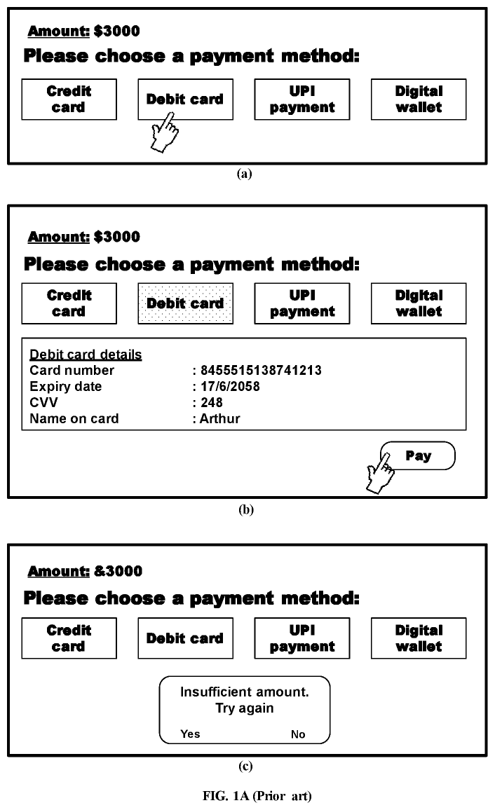

Although the FIG. 1 shows the hardware components of the electronic device 100 but it is to be understood that other embodiments are not limited thereon. In other embodiments, the electronic device 100 may include less or more number of components. Further, the labels or names of the components are used only for illustrative purpose and does not limit the scope of the invention. One or more components can be combined together to perform same or substantially similar function for aggregating the sources for the payment to the financial transaction.

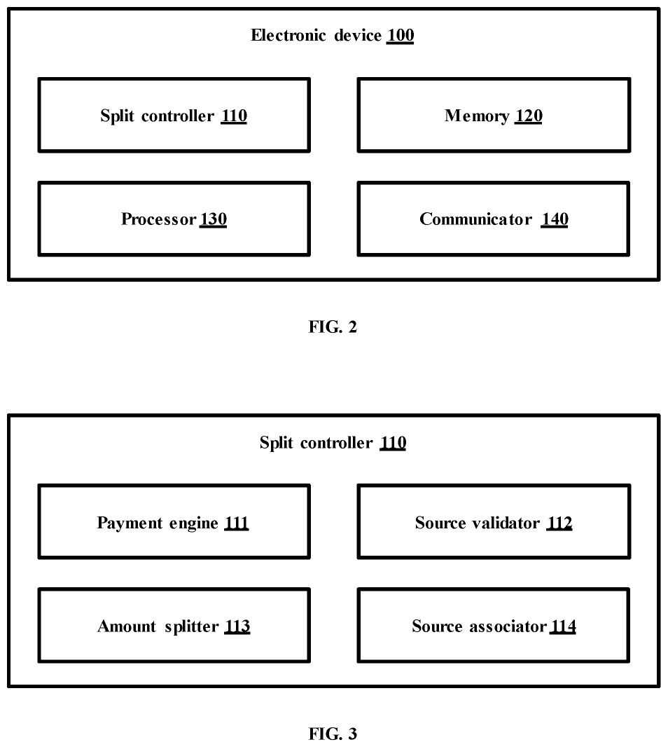

FIG. 3 is a block diagram of the split controller 110 for splitting the specific amount for the payment, according to an embodiment as disclosed herein. In an embodiment, the split controller 110 includes a payment engine 111, a source validator 112, an amount splitter 113, and a source associator 114. The payment engine 111 displays the request for the payment of the specified amount on the display. The source validator 112 determines the plurality of sources that meets the at least one payment criteria for the payment of the specified amount. In an embodiment, the source validator 112 identifies the sources in the plurality of sources, eligible for the payment according to the payment methods available at the payment entity. Further, the source validator 112 selects the eligible sources for determining whether the eligible sources meets the at least one payment criteria for the payment of the specified amount. The amount splitter 113 automatically splits the specified amount into the plurality of portions based on the at least one payment criteria. The source associator 114 associates the at least one portion from the plurality of portions of the specified amount to each of the sources based on the at least one payment criteria. The payment engine 111 performs the payment of the specified amount with the payment entity based on the at least one associated portion of the specified amount with each of the sources. The payment engine 111 provides the response for the payment of the specified amount.

In an embodiment, the payment engine 111 provides the alert to the user in response to approaching close to the financial budget (e.g. monthly financial budget) and reached the financial budget. In an embodiment, the payment engine 111 provides another alert to the user in response to expiring the source. In an embodiment, the payment engine 111 automatically suggests the source for the payment to the user based on the currency used at the source and the currency required for the financial transaction. In an embodiment, the payment engine 111 performs the currency conversion on the amount in the source for performing the payment.

Although the FIG. 3 shows the hardware components of the split controller 110 but it is to be understood that other embodiments are not limited thereon. In other embodiments, the split controller 110 may include less or more number of components. Further, the labels or names of the components are used only for illustrative purpose and does not limit the scope of the invention. One or more components can be combined together to perform same or substantially similar function for splitting the specific amount for the payment.

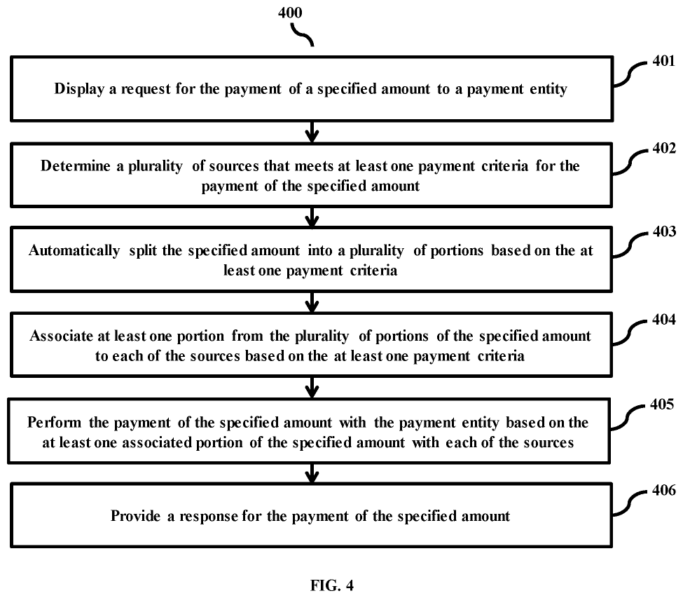

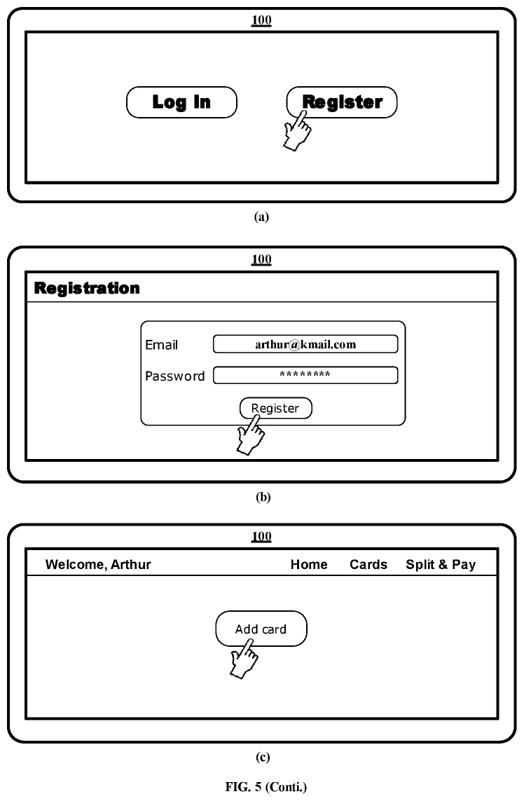

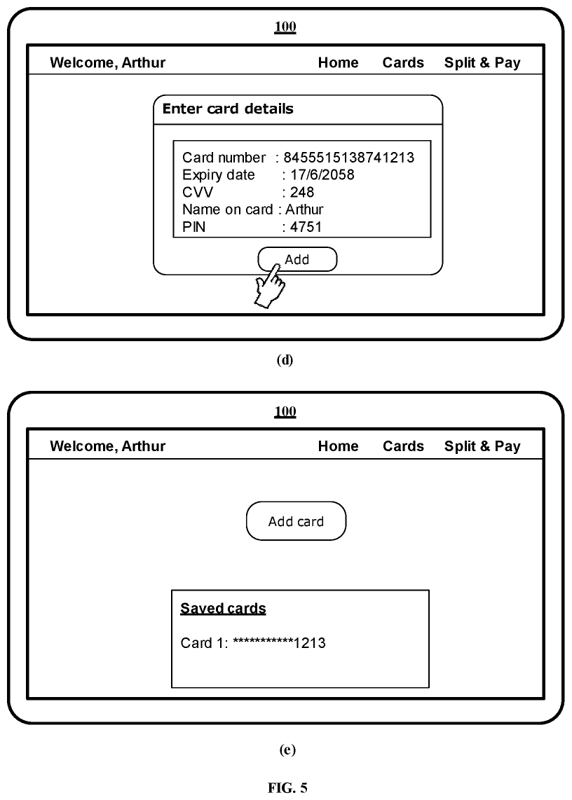

FIG. 4 is a flow diagram 400 illustrating a method of aggregating the sources and splitting the specific amount for the payment, according to an embodiment as disclosed herein. At 401, the method includes displaying the request for the payment of the specified amount to the payment entity. In an embodiment, the method allows the payment engine 111 to display the request for the payment of the specified amount to the payment entity on the display or the display device. At 402, the method includes determining the plurality of sources that meets the at least one payment criteria for the payment of the specified amount. In an embodiment, the method allows the source validator 112 to determine the plurality of sources that meets the at least one payment criteria for the payment of the specified amount. At 403, the method includes automatically splitting the specified amount into the plurality of portions based on the at least one payment criteria. In an embodiment, the method allows the amount splitter 113 to automatically splitting the specified amount into the plurality of portions based on the at least one payment criteria.

At 404, the method includes associating the at least one portion from the plurality of portions of the specified amount to each of the sources based on the at least one payment criteria. In an embodiment, the method allows the source associator 114 to associate the at least one portion from the plurality of portions of the specified amount to each of the sources based on the at least one payment criteria. At 405, the method includes performing the payment of the specified amount with the payment entity based on the at least one associated portion of the specified amount with each of the sources. In an embodiment, the method allows the payment engine 111 perform the payment of the specified amount with the payment entity based on the at least one associated portion of the specified amount with each of the sources. At 406, the method includes providing the response for the payment of the specified amount. In an embodiment, the method allows the payment engine 111 to provide the response for the payment of the specified amount. In an embodiment, the proposed method for payment of the specific amount is used to transfer the specific amount to a bank account of the payment entity.

The various actions, acts, blocks, steps, or the like in the flow diagram 400 may be performed in the order presented, in a different order or simultaneously. Further, in some embodiments, some of the actions, acts, blocks, steps, or the like may be omitted, added, modified, skipped, or the like without departing from the scope of the invention.

FIG. 5 illustrates an example scenario of registering bank cards at the electronic device 100 for aggregating the bank cards for the payment, according to an embodiment as disclosed herein. In the example scenario, the electronic device 100 displays an option for registering the fund sources (e.g. bank cards) and an option for login. Consider, the user does not register any fund sources with the electronic device 100. Therefore, the user provides an input for the registration of the fund sources to the electronic device 100 by taping on the option for the registration. The electronic device 100 initiates the registration of the fund sources (e.g. bank cards), in response to receiving the input on the option for the registration as shown in notation (a) of the FIG. 5.

Further, the electronic device 100 allows the user to input a mail ID and a password to generate an account for the user. In response to accepting the mail ID and the password of the user, the electronic device 100 generates the account for the user as shown in notation (b) of the FIG. 5. Further, the electronic device 100 displays a Home page of the account to the user. The Home page of the account includes an Add card option to register the fund source with the electronic device. A Cards page and a Split & Pay page is also available in the account of the user. The electronic device 100 is configured to provide details of registered sources in the Cards page. The electronic device 100 is configured to initiate the payment by splitting the amount and associating each portion of amount to one fund source in the Split & Pay page.

Consider, the user inputs on the Add card option as shown in notation (c) of the FIG. 5. Further, the electronic device 100 displays an option for the user to enter the details of the fund source. Consider, the user enters the details of the debit card 1 to register the debit card 1 with the electronic device 100 as shown in notation (d) of the FIG. 5. In response to successfully registering the debit card 1, the electronic device 100 returns to display the Home page to the user as shown in notation (e) of the FIG. 5. The electronic device 100 displays the registered card details for a time duration in the Home page and moves the registered card details to the Cards page.

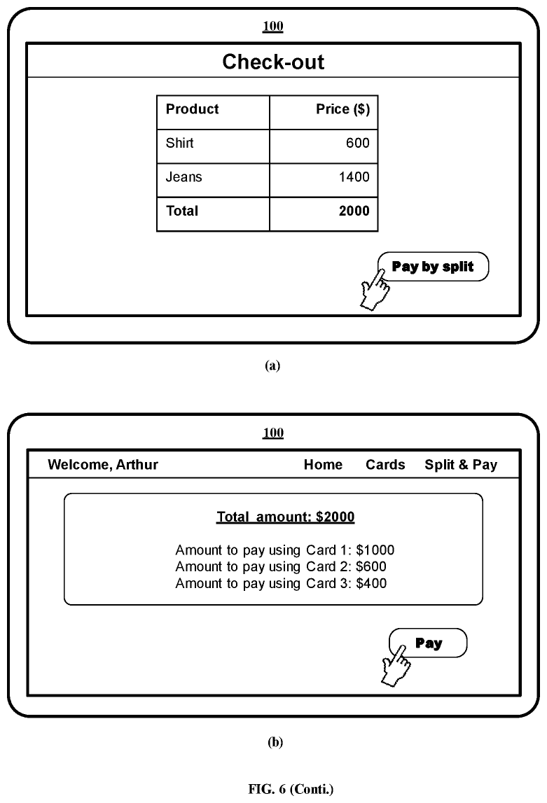

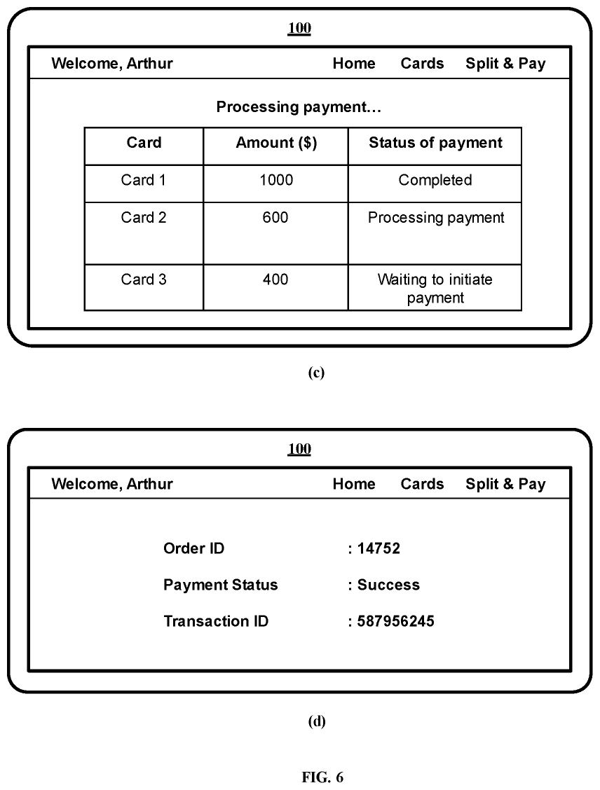

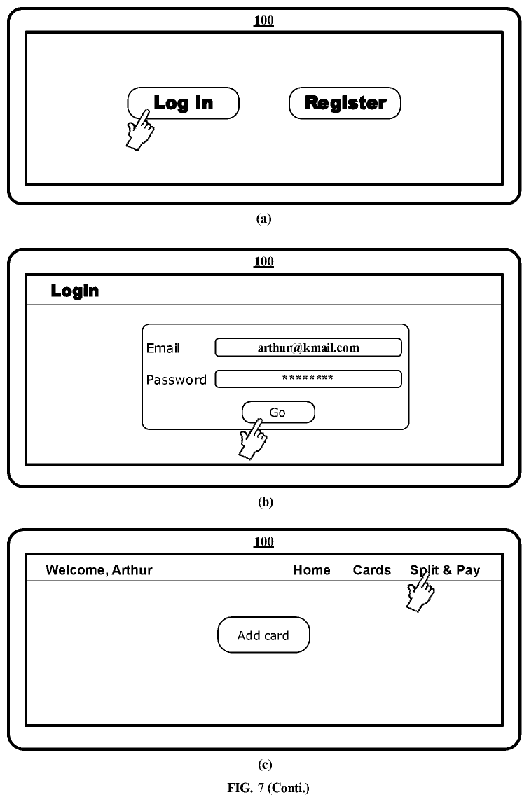

FIG. 6 illustrates an example scenario of paying the specific amount of the products in an e-commerce application by splitting the specific amount using the electronic device 100, according to an embodiment as disclosed herein. Consider, the account and four bank cards of the user are pre-registered with the electronic device 100. Consider, the user wants to buy certain products from the e-commerce application in the example scenario. Consider, the user reaches a check-out page of the e-commerce application in the electronic device 100 to pay for the products in the cart of the e-commerce application. The products in the cart includes a Shirt and a Jeans. The total amount to pay for the products in the cart is 2000 dollars. The user selects the pay by split option in the check-out page for doing payment of the amount according to the proposed method as shown in a notation (a) of the FIG. 6.

The electronic device 100 automatically logins to the account of the user and displays the home page of the account, in response to receiving the user input to pay the total amount in the e-commerce application. Further, the electronic device 100 determines that three bank cards out of the four bank cards are eligible to do the payment based on the payment methods providing by the e-commerce application. Further, the electronic device 100 defines the payment criteria based on the payment parameters of the three bank cards. Further, the electronic device 100 splits the total amount $2000 to three portions, i.e. $1000, $600 and $400 based on the payment criteria. Further, the electronic device 100 associates the portions $1000, $600, and $400 with the first card, the second card and the third card respectively based on the payment criteria. Further, the electronic device 100 displays each portion of the total amount and the associated bank card as shown in a notation (b) of the FIG. 6.

When the user is fine with the association of the three portions of the total amount with the three bank cards, the user selects the pay option in the electronic device 100 for paying the portions of the total amount. The electronic device 100 initiates the payment of each portion of the total amount sequentially as shown in a notation (c) of the FIG. 6, in response to receiving the user input to pay the portions of the total amount. Further, the electronic device 100 displays a status of the payment of each portion of the total amount while processing the payment. In response to completing the payment of the three portions of the total amount, the electronic device 100 provides the response to the user as shown in a notation (d) of the FIG. 6. The response includes the order ID, the payment status of the total amount, the transaction ID.

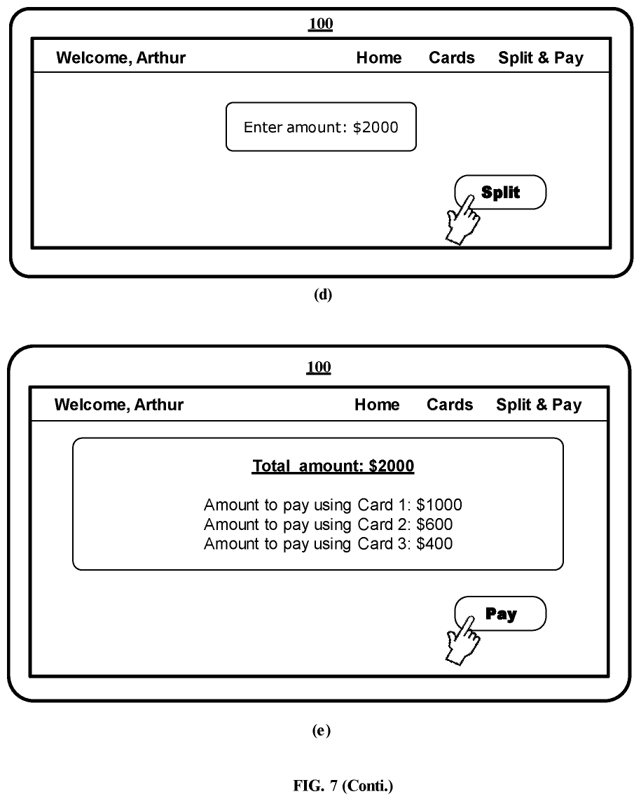

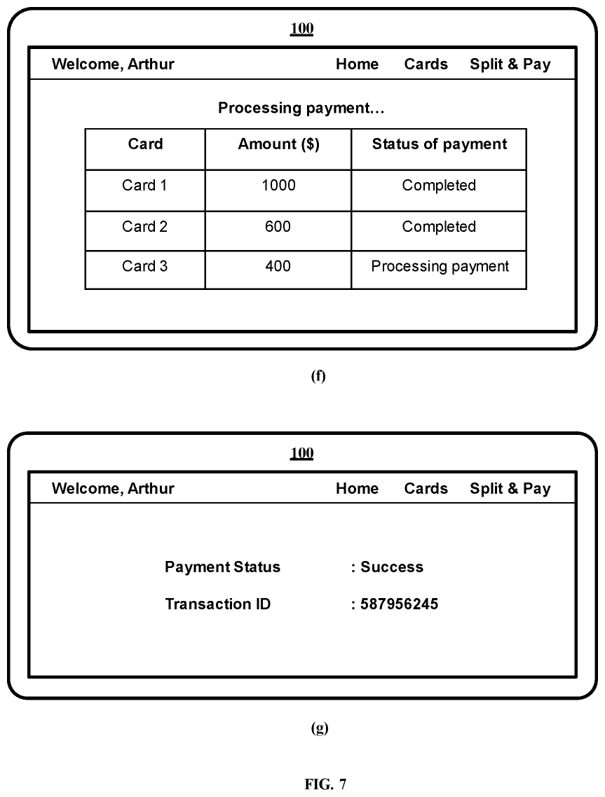

FIG. 7 illustrates an example scenario of paying the specific amount by splitting the specific amount using the electronic device 100 in response to entering the specific amount by the user to the electronic device 100, according to an embodiment as disclosed herein. Consider, the account and the three bank cards of the user are pre-registered with the electronic device 100. Consider, the user wants to transfer the specify amount $2000 to a bank account of the merchant in the example scenario. Initially, the user provides an input to the electronic device 100 for initiating the login to the account as shown in notation (a) of the FIG. 7. Further, the electronic device 100 allows the user to input the mail ID and the password to logging to the account. In response to accepting the mail ID and the password of the user, the electronic device 100 opens the account of the user and displays the Home page of the account as shown in notation (b) of the FIG. 7.

The user selects the Split & Pay page to transfer the specific amount according to the proposed method as shown in a notation (c) of the FIG. 7. In response to receiving the user input on the Split & Pay page, the electronic device 100 requests the user to enter the amount to transfer. Further, the user enters the amount to transfer, and selects the option to split the amount to transfer as shown in a notation (d) of the FIG. 7. In response to receiving the input to split, the electronic device 100 defines the payment criteria based on the payment parameters of the three bank cards. Further, the electronic device 100 defines the payment criteria based on the payment parameters of the three bank cards. Further, the electronic device 100 splits the specific amount $2000 to three portions, i.e. $1000, $600 and $400 based on the payment criteria. Further, the electronic device 100 associates the portions $1000, $600, and $400 with the first card, the second card and the third card respectively based on the payment criteria. Further, the electronic device 100 displays each portion of the specific amount and the associated bank card as shown in a notation (e) of the FIG. 7.

When the user is fine with the association of the three portions of the specific amount with the three bank cards, the user selects the pay option in the electronic device 100 for paying the portions of the specific amount. The electronic device 100 initiates the payment of each portion of the specific amount sequentially as shown in a notation (f) of the FIG. 7, in response to receiving the user input to pay the portions of the specific amount. Further, the electronic device 100 displays the status of the payment of each portion of the specific amount while processing the payment. In response to completing the payment of the three portions of the specific amount, the electronic device 100 provides the response to the user as shown in a notation (g) of the FIG. 7. The response includes the payment status of the specific amount, the transaction ID.

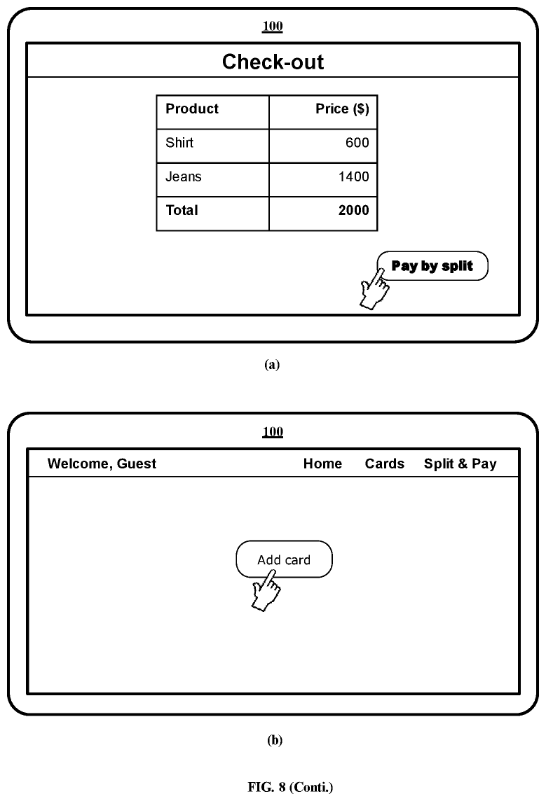

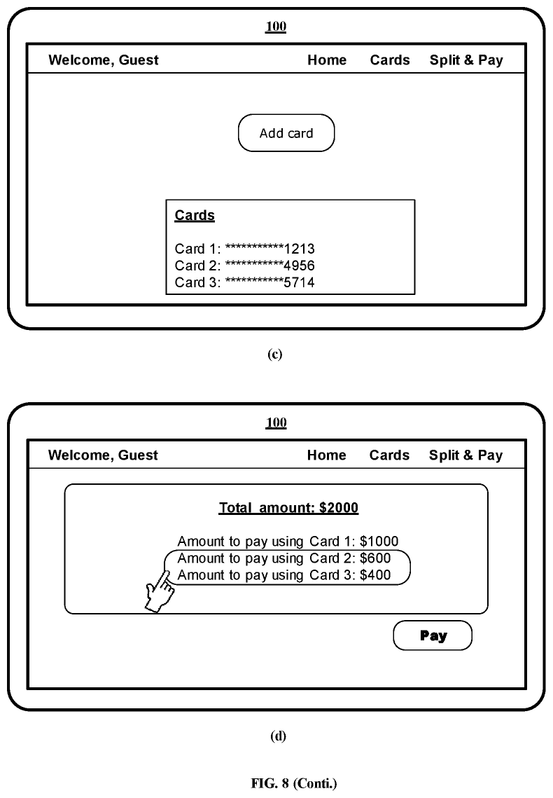

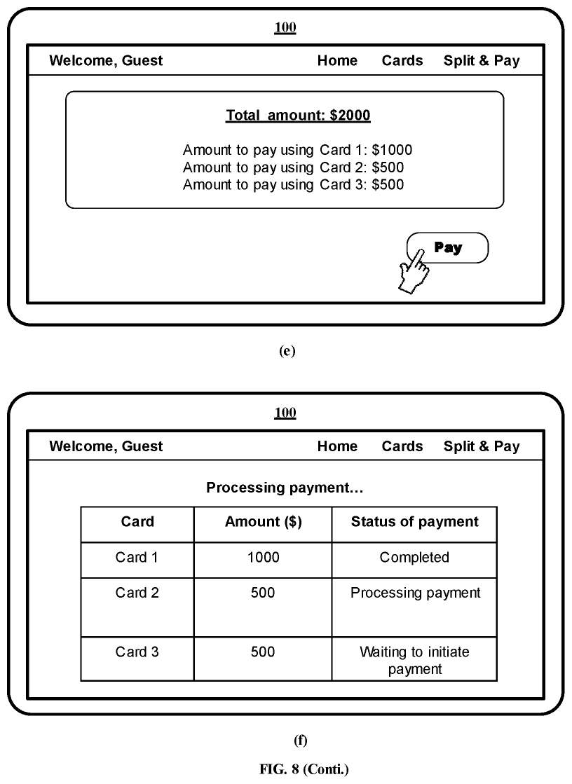

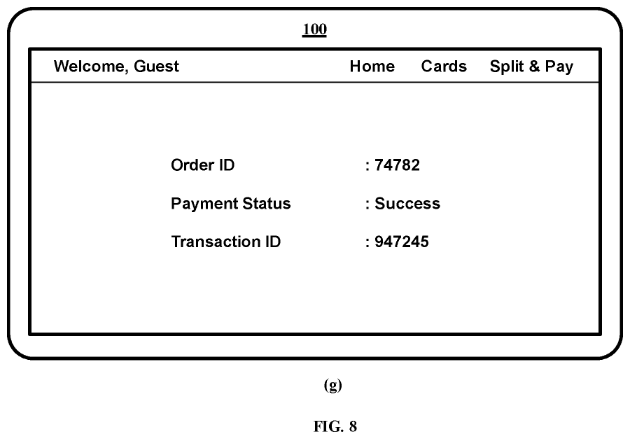

FIG. 8 illustrates an example scenario of paying the specific amount of the products in the e-commerce application by manually splitting the specific amount, according to an embodiment as disclosed herein. Consider, the user wants to buy certain products from the e-commerce application in the example scenario. Consider, the user reaches the check-out page of the e-commerce application in the electronic device 100 to pay for the products in the cart of the e-commerce application. The products in the cart includes the Shirt and the Jeans. The total amount to pay for the products in the cart is 2000 dollars. The user selects the pay by split option in the check-out page for doing payment of the amount according to the proposed method as shown in a notation (a) of the FIG. 8.

The electronic device 100 automatically displays the home page of a guest account to split the total amount, in response to receiving the user input to pay the total amount in the e-commerce application. Further, the user inputs on the Add card option as shown in notation (b) of the FIG. 8. Further, the electronic device 100 displays the option for the user to enter the details of the fund source. Consider, the user enters the details of the debit card 1, the credit card 1 and the net banking to register the debit card 1 (i.e. card 1), the credit card 1 (i.e. as card 2) and the net banking account (i.e. as card 3) respectively with the electronic device 100 as shown in notation (c) of the FIG. 8. In response to successfully registering the debit card 1, the credit card 1 and the net banking account, the electronic device 100 splits the total amount $2000 to three portions, i.e. $1000, $600 and $400 based on the payment criteria. Further, the electronic device 100 associates the portions $1000, $600, and $400 with the card 1, the card 2 and the card 3 respectively based on the payment criteria.

Further, the electronic device 100 displays each portion of the total amount and the associated bank card as shown in a notation (d) of the FIG. 8. Consider, the user wants to modify the portions of the total amount associated with the card 2 and the card 3. The user selects on the portions of the total amount associated with the card 2 and the card 3 to modify. In response to modifying the portions of the total amount associated with the card 2 and the card 3, the electronic device 100 displays each portion of the total amount and the associated bank card as shown in a notation (e) of the FIG. 8. Further, the user selects the pay option in the electronic device 100 for paying the portions of the total amount. The electronic device 100 initiates the payment of each portion of the total amount sequentially as shown in a notation (f) of the FIG. 8, in response to receiving the user input to pay the portions of the total amount. Further, the electronic device 100 displays the status of the payment of each portion of the total amount while processing the payment. In response to completing the payment of the three portions of the total amount, the electronic device 100 provides the response to the user as shown in a notation (g) of the FIG. 8. The response includes the order ID, the payment status of the total amount, the transaction ID.

The embodiments disclosed herein can be implemented using at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method of aggregating sources for a payment to a financial transaction using an electronic device (100), comprising:
displaying, by the electronic device (100), a request for the payment of a specified amount to a payment entity;
determining, by the electronic device (100), a plurality of sources that meets at least one payment criteria for the payment of the specified amount;
automatically splitting, by the electronic device (100), the specified amount into a plurality of portions based on the at least one payment criteria;
associating, by the electronic device (100), at least one portion from the plurality of portions of the specified amount to each of the sources based on the at least one payment criteria;
performing, by the electronic device (100), the payment of the specified amount with the payment entity based on the at least one associated portion of the specified amount with each of the sources; and
providing, by the electronic device (100), a response for the payment of the specified amount.

2. The method as claimed in claim 1, wherein the at least one payment criteria is dynamically defined based on a plurality of payment parameters associated with each of the sources.

3. The method as claimed in claim 2, wherein the plurality of payment parameters comprises at least one of a type of payment to be made, a geo-location at the payment to be made, a payment limit of a source for the payment, a total balance available in the source, a success rate of the source for the payment, a time taken for the payment, a time taken for a refund of the payment, a security method used by the source for the payment, a personal preference of the source for the payment, an additional fee for the payment, an additional fee for the refund, an offered reward for using the source for the payment, and an expiry status of the source.

4. The method as claimed in claim 1, wherein the at least one associated portion of the specified amount with each of the sources is confirmed by a user of the electronic device (100) before performing the payment.

5. The method as claimed in claim 1, wherein the at least one associated portion of the specified amount with each of the sources is adjusted based on a feedback from a user of the electronic device (100) before performing the payment.

6. The method as claimed in claim 1, wherein the plurality of sources that meets the at least one payment criteria is associated with a payment method same as a payment method associated with the payment entity.

7. An electronic device (100) for aggregating sources for a payment to a financial transaction, comprising:
a memory (120);
a processor (130); and
a split controller (110), connected to the memory (120) and the processor (130), configured to:
display a request for the payment of a specified amount to a payment entity;
determine a plurality of sources that meets at least one payment criteria for the payment of the specified amount;
automatically split the specified amount into a plurality of portions based on the at least one payment criteria;
associate at least one portion from the plurality of portions of the specified amount to each of the sources based on the at least one payment criteria;
perform the payment of the specified amount with the payment entity based on the at least one associated portion of the specified amount with each of the sources; and
provide a response for the payment of the specified amount.

8. The electronic device (100) as claimed in claim 7, wherein the at least one payment criteria is dynamically defined based on a plurality of payment parameters associated with each of the sources.

9. The electronic device (100) as claimed in claim 8, wherein the plurality of payment parameters comprises at least one of a type of payment to be made, a geo-location at the payment to be made, a payment limit of a source for the payment, a total balance available in the source, a success rate of the source for the payment, a time taken for the payment, a time taken for a refund of the payment, a security method used by the source for the payment, a personal preference of the source for the payment, an additional fee for the payment, an additional fee for the refund, an offered reward for using the source for the payment, and an expiry status of the source.

10. The electronic device (100) as claimed in claim 7, wherein the at least one associated portion of the specified amount with each of the sources is confirmed by a user of the electronic device (100) before performing the payment.

11. The electronic device (100) as claimed in claim 7, wherein the at least one associated portion of the specified amount with each of the sources is adjusted based on a feedback from a user of the electronic device (100) before performing the payment.

12. The electronic device (100) as claimed in claim 7, wherein the plurality of sources that meets the at least one payment criteria is associated with a payment method same as a payment method associated with the payment entity.
